(19) United States
(12) Patent Application Publication
(10) Pub. No.: US 2015/0012252 A1
(43) Pub. Date: Jan. 8, 2015

(54) METHOD AND SYSTEM FOR DETERMINING WHETHER COPY NUMBER VARIATION EXISTS IN SAMPLE GENOME, AND COMPUTER READABLE MEDIUM

(71) Applicants: Xuyang Yin, Shenzhen (CN); Chunlei Zhang, Shenzhen (CN); Shengpei Chen, Shenzhen (CN); Chunsheng Zhang, Shenzhen (CN); Xiaoyu Pan, Shenzhen (CN); Hui Jiang, Shenzhen (CN); Xiuqing Zhang, Shenzhen (CN)

(72) Inventors: Xuyang Yin, Shenzhen (CN); Chunlei Zhang, Shenzhen (CN); Shengpei Chen, Shenzhen (CN); Chunsheng Zhang, Shenzhen (CN); Xiaoyu Pan, Shenzhen (CN); Hui Jiang, Shenzhen (CN); Xiuqing Zhang, Shenzhen (CN)

(73) Assignee: BGI Diagnosis Co., Ltd., Shenzhen (CN)

(21) Appl. No.: 14/373,072

(22) PCT Filed: Jan. 20, 2012
(86) PCT No.: PCT/CN2012/070680

§ 371 Date: Jul. 18, 2014

(51) Int. Cl. G06F 19/12; G06F 17/50

(52) U.S. Cl. CPC G06F 19/12; G06F 17/5009
USPC 703/2

(57) ABSTRACT

Provided are a method, system, and computer-readable medium for determining whether a copy number variation exists in a sample genome. The method includes sequencing a sample genome to obtain a sequencing result formed by multiple reads; comparing the sequencing result with a reference genome sequence to determine the distribution of the reads on the reference genome sequence; determining, based on the distribution of the reads on the reference genome sequence, multiple breakpoints on the reference genome sequence, wherein the number of the reads on either side of each breakpoint are significantly different; determining, based on the plurality of breakpoints, a detection window on the reference genome; determining, based on the reads falling in the detection window, a parameter; and determining, based on the difference between the first parameter and a preset threshold, whether a copy number variation exists in the sample genome against the detection window.

### TECHNICAL FIELD

Embodiments of the present disclosure generally relate to a method of determining whether copy number variation presents in a genome sample, and a system and a computer readable medium thereof.

### BACKGROUND

In fields of scientific research and application, problems of analyzing a single cell, a plurality of cells, or a trace of nucleic acid sample usually come out, for example, Pre-implantation Genetic Diagnosis (PGD) and Pre-implantation Genetic Screening (PGS) in a field of assisted reproductive technology involve analysis with a single germ cell, a single blastomeric cell or an embryonic cell; a field of non-invasive prenatal diagnosis technology involves problem of detecting a trace of fetal cells in maternal peripheral blood; Metagenomics involves analysis with a single or a trace of biological cell in environment; and disease or physical research involves analysis with a single cell in tissue or body fluid.

However, currently the method of determining copy number variation still needs to be improved.

### SUMMARY

Embodiments of the present disclosure seek to solve at least one of the problems existing in the related art to at least some extent.

Embodiments of a first broad aspect of the present disclosure provide a method of determining whether copy number variation presents in a genome sample. According to embodiments of the present disclosure, the method may comprise following steps: sequencing the genome sample, to obtain a sequencing result consisting of a plurality of reads; aligning the sequencing result to a reference genome sequence, to determine a distribution of the reads in the reference genome sequence; determining a plurality of breakpoints in the reference genome sequence based on the distribution of the reads in the reference genome sequence, wherein the number of reads has significance at both sides of the breakpoints; determining a detection window in the reference genome based on the plurality of the breakpoints; determining a first parameter based on reads falling in the detection window; and determining whether the copy number variation presents in the genome sample against the detection window based on difference between the first parameter and a preset threshold. By using the method of determining whether copy number variation presents in a genome sample according to embodiments of the present disclosure, whether copy number variation presents in a genome sample may be effectively determined, which is suitable for various copy number variations, included but not limited to aneuploidy of chromosome, deletion of chromosome, and addition, micro-deletion and micro-repetition of chromosome fragments.

Embodiments of a second broad aspect of the present disclosure provide a system for determining whether copy number variation presents in a genome sample. According to embodiments of the present disclosure, the system may comprise:

a sequencing apparatus, configured to sequence the genome sample, to obtain a sequencing result consisting of a plurality of reads; an analysis apparatus, connected to the sequencing apparatus, configured to determine whether copy number variation presents in the genome sample based on the sequencing result, wherein the analysis apparatus further comprises: an aligning unit, configured to align the sequencing result to a reference genome sequence, to determine a distribution of the reads in the reference genome sequence; a breakpoint determining unit, connected to the aligning unit, configured to determine a plurality of breakpoints in the reference genome sequence, based on the distribution of the reads in the reference genome sequence, wherein the number of reads has significance at both sides of the breakpoints; a detection window determining unit, connected to the breakpoint determining unit, configured to determine a detection window in the reference genome based on the plurality of the breakpoints; a parameter determining unit, connected to the detection window determining unit, configured to determine a first parameter based on reads falling in the detection window; and a determining unit, connected to the parameter determining unit, configured to determine whether the copy number variation presents in the genome sample against the detection window based on difference between the first parameter and a preset threshold. By using the system for determining whether copy number variation presents in a genome sample according to embodiments of the present disclosure, the method of determining whether copy number variation presents in a genome sample according to embodiments of the present disclosure may be effectively implemented, which is suitable for various copy number variations, included but not limited to aneuploidy of chromosome, deletion of chromosome, and addition, micro-deletion and micro-repetition of chromosome fragments.

Embodiments of a third broad aspect of the present disclosure provide a computer readable medium. According to embodiments of the present disclosure, the computer readable medium is configured to perform by a processor to determine whether copy number variation presents in a genome sample through following steps: aligning the sequencing result to a reference genome sequence, to determine a distribution of the reads in the reference genome sequence; determining a plurality of breakpoints in the reference genome sequence based on the distribution of the reads in the reference genome sequence, wherein the number of reads has significance at both sides of the breakpoints; determining a detection window in the reference genome based on the plurality of the breakpoints; determining a first parameter based on reads falling in the detection window; and determining whether the copy number variation presents in the genome sample against the detection window based on difference between the first parameter and a preset threshold. By virtue of the computer readable medium, the method of determining whether copy number variation presents in a genome sample according to embodiments of the present disclosure may be effectively implemented, so as to effectively determine whether copy number variation presents in a genome sample, which is suitable for various copy number variations, included but not limited to aneuploidy of chromosome, deletion of chromosome, and addition, micro-deletion and micro-repetition of chromosome fragments.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference the accompanying drawings, in which:

FIG. 1 is a flow chart showing a method of determining whether copy number variation presents in a genome sample according to an embodiment of the present disclosure;

FIG. 2 is a schematic diagram showing a system for whether copy number variation presents in a genome sample according to an embodiment of the present disclosure;

FIG. 3 is a flow chart showing a method of determining whether copy number variation presents in a genome sample according to another embodiment of the present disclosure;

FIG. 4 is an image showing chromosome karyotype analysis of a sample S1 according to embodiments of the present disclosure, in which the left panel shows a result obtained by the method of detecting copy number variation according to an embodiment of the present disclosure with a single embryonic cell which has been subjected to a whole genome amplification, the right panel shows a result obtained by directly sequencing (without subjecting to the whole genome amplification firstly) with DNA extracted from the same single embryonic cell; and

FIG. 5 an image showing chromosome karyotype analysis of a sample S2 according to embodiments of the present disclosure, in which the left panel shows a result obtained by the method of detecting copy number variation according to an embodiment of the present disclosure with a single embryonic cell which has been subjected to a whole genome amplification, the right panel shows a result obtained by directly sequencing (without subjecting to the whole genome amplification firstly) with DNA extracted from the same single embryonic cell.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure

In addition, terms such as “first” and “second” are used herein for purposes of description and are not intended to indicate or imply relative importance or significance. Thus, features defined with “first” or “second” may explicitly or implicitly include one or more of said feature. Furthermore, in descriptions of the present disclosure, unless otherwise specified, “a plurality of” refers to two or more. If not specified, in formula or signs used herein, the same alphabet represents a same meaning.

I. Method of Determining Whether Copy Number Variation Presents in a Genome Sample

According to a first aspect of the present disclosure, there is provided a method of determining whether copy number variation presents in a genome sample in the present disclosure. Term of “copy number variation (CNV)” used herein refers to abnormality of chromosome or chromosome fragment copy number, including but not limited to chromosome aneuploidy, chromosome fragment deletion, addition, micro-deletion and micro-repeat of chromosome fragment.

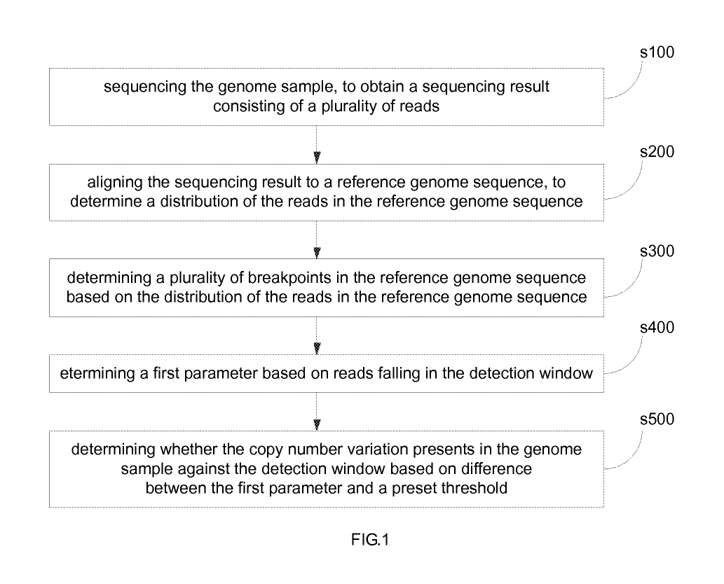

Referring to FIG. 1, the method of determining whether copy number variation presents in a genome sample according to embodiments of the present disclosure comprises:

S100: Sequencing the Genome Sample, to Obtain a Sequencing Result Consisting of a Plurality of Reads

According to embodiments of the present disclosure, types of the genome samples with which the method of the present disclosure are not subjected to special restrictions, which may be a whole genome or a part of a genome, for example, chromosome or chromosome fragment. Besides, according to embodiments of the present disclosure, prior to the step of sequencing the genome sample, the method of determining whether copy number variation presents in a genome sample may further comprise a step of extracting the genome sample from a biological sample. Accordingly, the biological sample may be directly used as raw material, for obtaining information regarding whether the biological sample has copy number variation, so as to reflect health status of organisms. According to embodiments of the present disclosure, the used biological sample is not subjected to special restrictions. According to some specific examples of the present disclosure, the biological sample is any one selected from a group consisting of blood, urine, saliva, tissue, germ cells, oosperm, blastomere and embryo. It would be appreciated by those skilled in the art that different biological samples may be used for analyzing different diseases. Accordingly, these samples may be conveniently obtained from organisms, and different samples may be used specifically directing to certain diseases, so as to selecting specific means for analyzing the certain diseases. For example, for a subject possibly suffering a certain cancer, a sample may be collected from cancerous tissue or juxtacancerous tissue, from which cells are further isolated for analysis, accordingly, whether such tissue become cancerous may be accurately determined as early as possible. According a specific example of the present disclosure, a single cell may be used as the biological sample. According to embodiments of the present disclosure, methods and devices of isolating a single cell from a biological sample are not subjected to special restrictions. According to some specific examples of the present disclosure, a single cell may be isolated from a biological sample using at least one of dilution, mouth-controlled pipette, micromanipulation (micro-dissection is preferred), flow cytometry isolation, microfluidics. Accordingly, a single cell may be effectively and conveniently obtained from a biological sample, to implement subsequent steps. Then, efficiency of determining whether copy number variation presents in a genome sample may be further improved.

Besides, according to embodiments of the present disclosure, methods of sequencing the genome sample are not subjected to special restrictions. According to an embodiment of the present disclosure, the step of sequencing the genome sample further comprises following sub-steps of: firstly amplifying the genome sample, to obtain an amplified genome sample; secondly, constructing a sequencing-library with the amplified genome sample; finally sequencing the constructed sequencing-library, to obtain the sequencing result consisting of a plurality of reads. Accordingly, whole genome information of the sequencing result of the genome sample may be effectively obtained, and a single cell genome or a trace of nucleic acid sample may be subjected to effective sequencing, which may further improve efficiency of determining whether copy number variation presents in a genome sample. Those skilled in the art may choose different methods of constructing a sequencing-library in accordance with specific solutions used in genome sequencing techniques. A detailed process of constructing a genome sequencing-library may refer to a specification provided by sequencing-instrument manufacturer, such as Illumina Company, for example Multiplexing Sample Preparation Guide (Part#1005063; February 2010), which is incorporated herein by reference.

Optionally, for the step of extracting the genome sample from the biological sample when being a single cell, according to embodiments of the present disclosure, the method may further comprise a step of lysing the single cell, to release whole genome of the single cell. According to some examples of the present disclosure, methods of lysing the single cell to release whole genome are not subjected to special restrictions, as long as the single cell is lysed, preferably the single cell is fully lysed. According to specific examples of the present disclosure, the single cell is lysed using an alkaline lysate, to release whole genome of the single cell. Inventors of the present disclosure find out that the step of lysing the single cell may effectively lyse the single cell to release whole genome, and accuracy may be improved when subjecting the released whole genome to sequencing, which may further improve efficiency of determining whether copy number variation presents in a genome sample. According to embodiments of the present disclosure, methods of amplifying a single cell whole genome are not subjected to special restrictions, a PCR-based method may be used, for example PEP-PCR, DOP-PCR and OmniPlex WGA; a non-PCR-based method may be also used, for example Multiple Displacement Amplification (MDA). According to specific examples of the present disclosure, the PCR-based method is preferably used, for example OmniPlex WGA. A commercial kit, including but not limited to GenomePlex from Sigma Aldrich, PicoPlex from Rubicon Genomics, REPLI-g from Qiagen, illustra GenomiPhi from GE Healthcare and etc, may be used. According to specific examples of the present disclosure, prior to the sub-step of constructing a sequencing-library, the single cell whole genome may be amplified by OmniPlex WGA. Accordingly, the whole genome may be effectively amplified, which may further improve efficiency of determining whether copy number variation presents in a genome sample. According to embodiments of the present disclosure, the sub-step of sequencing the whole genome sequencing-library is performed by at least one selected from Next-Generation sequencing technology consisting of Hiseq system of Illumina Company, Miseq system of Illumina Company, Genome Analyzer (GA) system of Illumina Company, 454 FLX of Roche Company, SOLiD system of Applied Biosystems Company, Ion Torrent system of Life Technologie Company. Accordingly, characteristics of high-throughput and deep sequencing of these sequencing apparatus may be used, which further improves efficiency of determining whether copy number variation presents in a genome sample. Obviously, it would be appreciated by those skilled in the art that other sequencing methods and apparatuses may also be used for whole genome sequencing, for example Third-Generation sequencing technology (i.e., single molecule sequencing technology) such as any one of HeliScope system from Helicos BioSciences Company, RS system from PacBio Company and etc, as well as more advanced sequencing technology which may be developed later. According to embodiments of the present disclosure, lengths of sequencing data obtained by whole genome sequencing are not subjected to special restrictions. According to an specific example of the present disclosure, the plurality of sequencing data have an average length of about 50 bp. The inventors of the present disclosure surprisingly find out that sequencing data having a length of about 50 bp may greatly facilitate subjecting the sequencing data to analyzing, which improves analysis efficiency and significantly reduces cost for analysis, by which further improves efficiency of determining chromosome aneuploidy of a single cell and reduces cost of determining chromosome aneuploidy of a single cell. Term of “average length” used herein refers to a mean value of length values of every sequencing data.

S200: Aligning the Sequencing Result to a Reference Genome Sequence, to Determine a Distribution of the Reads in the Reference Genome Sequence

After completing the step of sequencing the genome sample, the obtained sequencing result includes a plurality of sequencing data. The obtained sequencing result is aligned to a reference genome sequence, so as to determine a location of the obtained sequencing result in the reference genome sequence. According to embodiments of the present disclosure, any known methods may be used to calculate the total number of these sequencing data. For example, software provided by sequencing instrument manufacturer may be used for analysis. Short Oligonucleotide Analysis Package (SOAP) and Burrows-Wheeler Aligner (BWA) are preferably used, which align reads to a reference genome sequence, to obtain a location of reads in the reference sequence. A default parameter provided by program of the software may be used in alignment, or a parameter may be selected by those skilled in the art as required. In an embodiment of the present disclosure, SOAPaligner/soap2 is used as alignment software.

According to embodiments of the present disclosure, the reference genome sequence may be a standard human genome reference sequence in NCBI database (for example may be hg18, NCBI Build 36); or may be a part of a known genome sequence, for example may be at least one sequence selected from a group consisting of human chromosome 21, chromosome 18, chromosome 13, chromosome X and chromosome Y.

According to embodiments of the present disclosure, by the step of aligning the sequencing result to a reference genome sequence, sequences which are uniquely aligned to the reference genome sequence may be selected for subsequent analysis. Accordingly, interference to analysis of copy number variation by repeat sequences may be avoided, which further improves efficiency of determining whether copy number variation presents in a genome sample.

S300: Determining a Plurality of Breakpoints in the Reference Genome Sequence Based on the Distribution of the Reads in the Reference Genome Sequence

Term of “breakpoints” used herein refers to such kind of sites in a genome, in which the number of the reads on either side of the site are significantly different between these two regions. As reads derive from the genome sample, when a certain region presents copy number variation in the genome sample, the number of the reads corresponded in the region also changes significantly. Accordingly, after determining a plurality of breakpoints, copy number variation probably presents in a region between two successive breakpoints may be preliminary determined.

According to embodiments of the present disclosure, the step of determining a plurality of breakpoints in the reference genome sequence further comprises following sub-steps:

Firstly, the reference genome sequence is divided into a plurality of primary windows having a predetermined length, and reads falling into the primary windows are determined. According to specific examples of the present disclosure, by conventional alignment programs, reads contained in the obtained sequencing result may be aligned to the reference genome sequence, by which reads falling into the primary windows may be determined, for example, it may be accomplished in the step S200 above-described. According to specific examples of the present disclosure, the reads falling into each of the primary windows are uniquely-aligned reads. Accordingly, interference to analysis of copy number variation by repeat sequences may be avoided, which further improves efficiency of determining whether copy number variation presents in a genome sample.

Secondly, for at least one site in the reference genome sequence, determining the number of reads falling in the primary windows having the same number at both sides of the site. According to embodiments of the present disclosure, correlation analysis may be performed with all sites in the reference genome sequence, or with interested chromosome, for example such correlation analysis is performed with all sites in at least one of human chromosome 21, chromosome 18, chromosome 13, chromosome X and chromosome Y. According to embodiments of the present disclosure, each of the primary windows may have same or different length; an overlap may present between primary windows, as long as information of each primary window is known; each of the primary windows is preferably has a same length. According to embodiments of the present disclosure, each of the primary windows may have a length of 100 to 200 Kbp, preferably 150 Kbp. According to embodiments of the present disclosure, the number of the primary windows located at both sides of the site is not subjected to special restrictions, according to a specific example of the present disclosure, 100 of the primary windows may be selected from either side of the site respectively.

Thirdly, by statistical analysis, p value of the site may be determined, in which the p value represents that the number of reads falling in either side of the site has significance. If the p value of the site is smaller than a final p value, that the site is the breakpoints is determined. According to embodiments of the present disclosure, a range of the final p value may be determined by subjecting a known sequence sample to parallel analysis, according to a specific example of the present disclosure, the final p value is 1.1×10⁻⁵⁰.

According to an embodiment of the present disclosure, the sub-step of determining p value of the site further comprises:

For the selected site, primary windows having the same number at either side of the site are selected, the relative number of reads falling in each primary window Rᵢ is calculated, in which i represents the No. of the primary windows,

the relative number of reads falling in all primary windows Rᵢ are subjected to run test, to determine the p value of the site, in which

the relative number of reads is determined by following formula:

$${R}_{i} = {log}_{2} ( \frac{{r}_{i}}{\overline{r}} )$$

in which rᵢ represents the number of reads falling in the i-th primary window,

$$\overline{r} = \frac{1}{n} {\sum }_{i = 1}^{n} {r}_{i} ,$$

n represents the total number of the primary windows.

In details, the step of subjecting the relative number of the reads falling in all primary windows to run test further comprises: subjecting the relative number of reads falling in each of the primary windows Ri to a correction of GC content, to obtain corrected relative number of reads \tilde{R}ᵢ; determining the normalized number of reads falling in each of the primary windows Zi based on the corrected relative number of reads; and subjecting all of the normalized number of reads falling in each of the primary windows Zi to run test.

More specifically, the corrected relative number of reads \tilde{R}ᵢ is obtained by following steps:

Firstly GC content of each primary window is calculated;

Secondly, the GC content is divided into a plurality of regions in accordance with a predetermined value, and a mean value Mₛ of the relative number of reads falling in each of the plurality of regions is calculated, in which s is No. of the plurality of regions, according to embodiments of the present disclosure, the predetermined value may be any numerical value in a range of 0.0005 to 0.01, of which a corresponding region has a length of 50 k to 300 k, 0.001 is preferred, by which may performing a correlation with an optimal power.

Thirdly, the corrected relative number of reads \tilde{R}ᵢ is determined based on the =following formula:

\tilde{R}ᵢ=Rᵢ−Mₛ.

Lastly, the normalized number of reads Zᵢ is determined based on the following formula, in which

$${Z}_{i} = ( {R}_{i} - {\tilde{R}}_{i} - mean ) / SD$$

$$mean = \frac{1}{n} {\sum }_{i = 1}^{n} ( {R}_{i} - {\tilde{R}}_{i} )$$

$$SD = \sqrt{\frac{1}{n - 1} {\sum }_{i = 1}^{n} {( {R}_{i} - {\tilde{R}}_{i} - mean )}^{2}} .$$

Accordingly, the number of reads may be subjected to correlation by GC content. Thus, an interference caused by bias of genome amplification may be eliminated, by which improves accuracy and efficiency of determining whether copy number variation presents in a genome sample.

After the plurality of breakpoints has been determined, a possibility that copy number variation presents in a region between two successive breakpoints may be preliminary determined. Accordingly such regions may be taken as the detection windows for further determining whether copy number variation presents. In the case of obtaining relative more breakpoints in the preliminary determination, the obtained breakpoints may be subjected to further screening. Accordingly, according to embodiments of the present disclosure, the step of determining a detection window in the reference genome based on the plurality of the breakpoints further comprises:

1) determining a plurality of candidate breakpoints, wherein other breakpoints present both before and after the candidate breakpoints;

2) determining p value of each candidate breakpoint, and removing a candidate breakpoint having the maximal p value;

3) performing the step 2) with rest of the candidate breakpoints until p values of the rest of the candidate breakpoints all smaller than the terminate p value, wherein the rest of the candidate breakpoints are taken as screened candidate breakpoints; and

4) determining a region between two successive screened candidate breakpoints as the detection window.

According to embodiments of the present disclosure, the p value of the candidate breakpoint is obtained by following steps:

selecting a region between the candidate breakpoint and previous candidate breakpoint as a first candidate region, and selecting a region between the candidate breakpoint and next candidate breakpoint as a second candidate region;

subjecting the normalized number of reads falling in the primary windows Zi which are included both in the first candidate region and the second candidate region to run test (The run test is a nonparametric test, evaluating significant difference between two populations using evenly distributed status of mixed elements with two populations. Details regarding such test may refer to Wald A. W J. On a Test Whether Two Samples are from the Same Population. The Annals of Mathematical Statistics 1940; 11:147-162, which is incorporated herein by reference), to determine the p value of the candidate breakpoints.

According to embodiments of the present disclosure, the final p value is obtained by following steps:

based on a sequencing result of a control sample, repeating the step of determining a detection window in the reference genome, and recording p values of the breakpoints which are removed each time until the number of the breakpoints is zero, in which term of “control sample” used herein refers to a sample of which copy number variation does not present in a known nucleotide sequence; and

based on a distribution of the p values of removed breakpoints, the final p value is determined, for example, a distribution diagram is plotted with the p values of removed breakpoints, a p value having a maximal changing trend is taken as the final p value (p_{final}).

According to specific examples of the present disclosure, the final p value is 1.1×10⁻⁵⁰.

S400: Determining a First Parameter Based on Reads Falling in the Detection Window

After the detection windows have been determined, reads contained in the detection windows may be subjected to statistical analysis, so as to determine whether copy number variation presents in the detection windows. According to an embodiments of the present disclosure, the step of determining the first parameter based on reads falling into the detection windows further comprises: determining a mean value of the normalized number of reads falling in all primary windows Z̅ which are included in the detection windows, in which the mean value of the normalized number of reads Z̅ is taken as the first parameter. The normalized number of reads has been specifically described above, which is omitted herein for brevity.

S500: Determining Whether the Copy Number Variation Presents in the Genome Sample Against the Detection Window Based on Difference Between the First Parameter and a Preset Threshold

According to embodiments of the present disclosure, the determined first parameter may be compared with a preset threshold, then based on difference between the first parameter and the present threshold, whether the copy number variation presents in the genome sample is determined regarding the specific detection window. Based on the sequencing result of the genome sample, the number of reads falling into a certain window is positively related to content of the certain window in chromosome or genome, accordingly by subjecting reads deriving from a certain window in the sequencing result to statistical analysis, whether the copy number variation presents in the genome sample may be effectively determined based on the certain window. Term of “preset threshold” used herein refers to relative parameter based on the certain window obtained by repeating the operations and analysis in the above embodiments using a normal genome sample having a known sequence. It would be appreciated that, relative parameter based on the certain window and relative parameter of normal cells may be obtained by same sequencing conditions and mathematics methods. Here, the relative parameter of normal cells may be used as the preset threshold. Besides, term “preset” used herein should be broadly understood, which may be predetermined by experiment, or may be obtained by parallel experiments when analyzing the biological sample. Term “parallel experiment” should be broadly understood, which may refer to sequencing and analyzing unknown and known samples at the same time, or may refer to performing the steps of sequencing and analyzing under same conditions successively. According to embodiments of the present disclosure, the preset threshold comprises a first threshold and a second threshold, by comparing the first parameter Z̅ to the first threshold and the second threshold, in the case of the first parameter Z̅ smaller than the first threshold, copy number reducing is determined (i.e., deletion), in the case of the first parameter Z̅ greater than the second threshold, copy number increasing is determined (i.e., addition), accordingly which type of the copy number variation may be determined. According to specific examples of the present disclosure, α=0.05 is set as a boundary of significance, by which type of the copy number variation is further determined.

By the method of determining whether copy number variation presents in a genome sample according to embodiments of the present disclosure, whether copy number variation in the genome sample may be effectively determined, which is suitable for various variations, including but not limited to chromosome aneuploidy, chromosome fragment deletion, fragment addition, addition, micro-deletion and micro-repeat of chromosome fragment. Copy number variation is the major factor inducing birth defect, which is also very common in embryo cultured in vitro, being a major reason leading to failure of reproduction in vitro. Copy number variation is also a pathogenic factor to many diseases such as cancer. The whole genome amplification is technique which can perform amplification in a range of whole genome with a single cell, a plurality cells or a trace of nucleic acid sample, which may increase sample amount on the premise of maintaining representativeness of the whole genome, to achieve the required sample amount. However, in general, a problem of amplification bias presents in the whole genome amplification, which brings in deviation to subsequent analysis. The method of determining whether copy number variation presents in a genome sample according to embodiments of the present disclosure, after the single cell or a trace of nucleic acid sample has been subjected to whole genome amplification, data is obtained by sequencing technology for analysis of copy number variation. On one hand, a problem of having difficulties in analyzing with a single cell or a trace of nucleic acid sample is solved by the whole genome amplification, on the other hand, bias to analyzing copy number variation induced by the whole genome amplification is avoided, which makes detection more accurate and more comprehensive, particularly detection efficiency may be further improved by a correlation of GC content. Besides, according to embodiments, during the sub-step of constructing sequencing-library with different samples, different indexes are introduced, by which a plurality samples may be subjected to test at the same time, which further improves efficiency of determining whether copy number variation presents in a genome sample. Using the method of determining whether copy number variation presents in a genome sample according to embodiments of the present disclosure, screening and diagnosing copy number variation prior to embryo implantation or noninvasive screening of fetal copy number variation may be determined, which is benefit to provide genetic counseling and basis for clinic decision; prenatal diagnosis may effectively prevent implantation of embryo with lesion, to present newborns with defects.

II System for Determining Whether Copy Number Variation Presents in a Genome Sample

According to a second aspect of the present disclosure, there is provided a system for determining whether copy number variation presents in a genome sample. Using the system may effectively implement the method of determining whether copy number variation presents in a genome sample above-described, so as to effectively determine whether copy number variation presents in the genome sample.

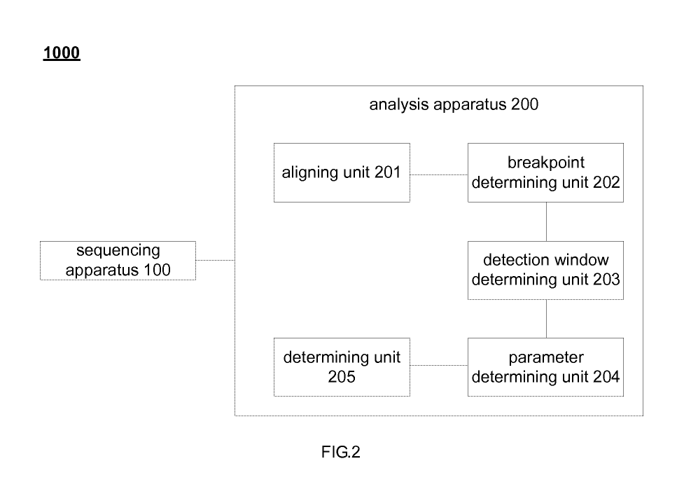

Referring to FIG. 2, according to embodiments of the present disclosure, the system 1000 for determining whether copy number variation presents in a genome sample comprises: a sequencing apparatus 100 and an analysis apparatus 200.

According to embodiments of the present disclosure, the sequencing apparatus 100 is configured to sequence the genome sample, to obtain a sequencing result consisting of a plurality of reads. According to embodiments of the present disclosure, the system 1000 for determining whether copy number variation presents in a genome sample may further comprise a genome extracting apparatus (not shown in Figs). The genome extracting apparatus is configured to extract the genome sample from a biological sample, and the genome extracting apparatus is connected to the sequencing apparatus 100 for providing the genome sample. Accordingly, the biological sample may be directly used as raw material, to obtain information whether copy number variation presents in the biological sample, so as to reflect health status of organisms. According to embodiments of the present disclosure, the sequencing apparatus 100 may further comprise: a genome amplifying unit, a sequencing-library constructing unit and a sequencing unit, in which the genome amplifying unit is configured to amplify the genome sample; the sequencing-library constructing unit, connected to the genome amplifying unit, is configured to construct a sequencing-library with the amplified genome sample; and the sequencing unit, connected to the sequencing-library constructing unit, is configured to sequence the sequencing-library. According to embodiments of the present disclosure, the sub-step of sequencing the whole genome sequencing-library is performed by at least one selected from Next-Generation sequencing technology (such as Hiseq system of Illumina Company, Miseq system of Illumina Company, Genome Analyzer (GA) system of Illumina Company, 454 FLX of Roche Company, SOLiD system of Applied Biosystems Company, Ion Torrent system of Life Technologie Company) and single molecule sequencing apparatus. Accordingly, characteristics of high-throughput and deep sequencing of these sequencing apparatus may be used, which further improves efficiency of determining whether copy number variation presents in a genome sample.

According to embodiments of the present disclosure, the analysis apparatus 200 is connected to the sequencing apparatus 100, to determine whether copy number variation presents in a genome sample based on the sequencing result. According to embodiments of the present disclosure, the analysis apparatus 200 further comprises: an aligning unit 201, a breakpoint determining unit 202, a detection window determining unit 203, a parameter determining unit 204 and a determining unit 205, in which the aligning unit 201 is configured to align the sequencing result to a reference genome sequence, to determine a distribution of the reads in the reference genome sequence. According to embodiments of the present disclosure, a known human genome sequence is preserved in the aligning unit 201 as the reference genome sequence, optionally, the reference genome sequence is at least one selected from human chromosome 21, chromosome 18, chromosome 13, chromosome X and chromosome Y. The breakpoint determining unit 202, connected to the aligning unit 201, is configured to determine a plurality of breakpoints in the reference genome sequence, based on the distribution of the reads in the reference genome sequence, as described above, the number of reads has significance between two sides of the breakpoints. The detection window determining unit 203, connected to the breakpoint determining unit 202, is configured to determine a detection window in the reference genome based on the plurality of the breakpoints. The parameter determining unit 204, connected to the detection window determining unit, is configured to determine a first parameter based on reads falling in the detection window. The determining unit 205, connected to the parameter determining unit 204, configured to determine whether the copy number variation presents in the genome sample against the detection window based on difference between the first parameter and a preset threshold.

According to embodiments, the breakpoint determining unit 202 further comprises a module for performing following sub-steps:

dividing the reference genome sequence into a plurality of primary windows having a predetermined length, and determining reads falling into the primary windows;

Firstly, the reference genome sequence is divided into a plurality of primary windows having a predetermined length, and reads falling into the primary windows are determined. According to specific examples of the present disclosure, by conventional alignment programs, reads contained in the obtained sequencing result may be aligned to the reference genome sequence, by which reads falling into the primary windows may be determined. According to embodiments of the present disclosure, each of the primary windows may have same or different length; an overlap may present between primary windows, as long as information of each primary window is known; each of the primary windows is preferably has a same length. According to embodiments of the present disclosure, each of the primary windows may have a length of 100 to 200 Kbp, preferably 150 Kbp. According to embodiments of the present disclosure, the number of the primary windows located at both sides of the site is not subjected to special restrictions, according to a specific example of the present disclosure, 100 of the primary windows may be selected from either side of the site respectively.

Secondly, p value of the site is determined; such p value may reflect significant difference of the number of reads between two sides of the site. Besides, the p value of the site is smaller than a final p value, the site is determined as the breakpoints. According to embodiments of the present disclosure, a range of the final p value may be determined by subjecting a known sequence sample to parallel analysis, according to a specific example of the present disclosure, the final p value is 1.1×10⁻⁵⁰.

According to embodiments of the present disclosure, the breakpoint determining unit 202 further comprises a module for performing following sub-steps:

For the selected site, the same number of the primary windows at either side of the site is selected respectively, and the relative number of reads falling in every primary window Ri is calculated, in which i represents No. of the primary windows,

the relative number of reads falling in all primary windows Rᵢ is subjected to run test, o determine the p value of the site, in which

the relative number of reads is determined by following formula:

$${R}_{i} = {log}_{2} ( \frac{{r}_{i}}{\overline{r}} )$$

in which rᵢ represents the number of reads falling in the i-th primary window,

$$\overline{r} = \frac{1}{n} {\sum }_{i = 1}^{n} {r}_{i} ,$$

n represents the total number of the primary windows.

According to embodiments of the present disclosure, the breakpoint determining unit 202 further comprises a module for performing followings to subject the relative number of the reads falling in all primary windows to run test:

subjecting the relative number of reads falling in each of the primary windows Rᵢ to a correction of GC content, to obtain corrected relative number of reads \tilde{R}ₜ;

determining the normalized number of reads falling in each of the primary windows Zᵢ based on the corrected relative number of reads; and

subjecting all of the normalized number of reads falling in each of the primary windows Zᵢ to run test.

According to embodiments of the present disclosure, the corrected relative number of reads \tilde{R}ᵢ is obtained by a module for performing following steps:

calculating GC content of each primary window;

dividing the GC content into a plurality of regions in a unit of 0.001, and calculating a mean value Mₛ of the relative number of reads falling in each of the plurality of regions, wherein s is No. of the plurality of regions;

determining the corrected relative number of reads \tilde{R}ᵢ based on the following formula:

\tilde{R}ᵢ=Rᵢ−Mₛ;

determining the normalized number of reads Z, based on the following formula:

wherein

$${Z}_{i} = ( {R}_{i} - {\tilde{R}}_{i} - mean ) / SD , wherein$$

$$mean = \frac{1}{n} {\sum }_{i = 1}^{n} ( {R}_{i} - {\tilde{R}}_{i} ) , \\ SD = \sqrt{\frac{1}{n - 1} {\sum }_{i = 1}^{n} {( {R}_{i} - {\tilde{R}}_{i} - mean )}^{2}} .$$

After the plurality of breakpoints has been determined, a possibility that copy number variation presents in a region between two successive breakpoints may be preliminary determined. Accordingly such regions may be taken as the detection windows for further determining whether copy number variation presents. In the case of obtaining relative more breakpoints in the preliminary determination, the obtained breakpoints may be subjected to further screening. According to embodiments of the present disclosure, based on the plurality of the breakpoints, the detection window determining unit further comprises a module for performing followings:

1) determining a plurality of candidate breakpoints, wherein other breakpoints present both before and after the candidate breakpoints;

2) determining p value of each candidate breakpoint, and removing a candidate breakpoint having the maximal p value;

3) performing the step 2) with rest of the candidate breakpoints until p values of the rest of the candidate breakpoints all smaller than the terminate p value, wherein the rest of the candidate breakpoints are taken as screened candidate breakpoints; and

4) determining a region between two successive screened candidate breakpoints as the detection window.

In which, according to embodiments of the present disclosure, the p value of the candidate breakpoint is obtained by following steps:

selecting a region between the candidate breakpoint and previous candidate breakpoint as a first candidate region, and selecting a region between the candidate breakpoint and next candidate breakpoint as a second candidate region;

subjecting the normalized number of reads falling in the primary windows Zi which are included both in the first candidate region and the second candidate region to run test, to determine the p value of the candidate breakpoints.

According to embodiments of the present disclosure, the final p value is obtained by following steps:

based on a sequencing result of a control sample, repeating the step of determining a detection window in the reference genome, and recording p values of the breakpoints which are removed each time until the number of the breakpoints is zero; and

determining the final p value, based on a distribution of the p values of removed breakpoints, for example, a distribution diagram is plotted with the p values of removed breakpoints, a p value having a maximal changing trend is taken as the final p value (p_{final}).

According to specific examples of the present disclosure, the final p value is 1.1×10⁻⁵⁰.

According to embodiments of the present disclosure, the parameter determining unit 204 further comprises a module for performing followings: determining a mean value of the normalized number of reads falling in all primary windows Z̅ which are included in the detection windows, in which the mean value of the normalized number of reads Z̅ is taken as the first parameter. Furthermore, a preset threshold is preserved in the determining unit 205, accordingly, the determining unit 205 may compare the first parameter determined in the parameter determining unit 204, so as to determine whether copy number variation presents in the obtained detection windows, in which according to embodiments of the present disclosure, the preset threshold comprises: a first threshold and a second threshold, by comparing the first parameter Z̅ to the first threshold and the second threshold, in the case of the first parameter Z̅ smaller than the first threshold, copy number reducing is determined (i.e., deletion), in the case of the first parameter Z greater than the second threshold, copy number increasing is determined (i.e., addition), accordingly which type of the copy number variation may be determined. According to specific examples of the present disclosure, α=0.05 is set as a boundary of significance, by which type of the copy number variation is further determined.

Accordingly, using the system for determining whether copy number variation presents in a genome sample according to embodiments of the present disclosure, the method of determining whether copy number variation presents in a genome sample according to embodiments of the present disclosure may be effectively implemented, so as to effectively determine whether copy number variation presents in the genome sample, which is suitable for various copy number variations, included but not limited to aneuploidy of chromosome, deletion of chromosome, and addition, micro-deletion and micro-repetition of chromosome fragments.

It should note that, it would be appreciated by those skilled in the art that, the above-described characteristics and advantages of the method of determining whether copy number variation presents in a genome sample is also suitable to the system for whether copy number variation presents in a genome sample, which are omitted for convenience and brevity.

III. Computer Readable Medium

According to a third aspect of the present disclosure, there is provided a computer readable medium. According to embodiments of the present disclosure, an order is preserved in the computer readable medium, the order is configured to perform by a processor to determine whether copy number variation presents in a genome sample through following steps: aligning the sequencing result to a reference genome sequence, to determine a distribution of the reads in the reference genome sequence; determining a plurality of breakpoints in the reference genome sequence based on the distribution of the reads in the reference genome sequence, wherein the number of reads has significance at both sides of the breakpoints; determining a detection window in the reference genome based on the plurality of the breakpoints; determining a first parameter based on reads falling in the detection window; and determining whether the copy number variation presents in the genome sample against the detection window based on difference between the first parameter and a preset threshold. Using the computer readable medium, the method of determining whether copy number variation presents in a genome sample according to embodiments of the present disclosure may be effectively implemented, so as to effectively determine whether copy number variation presents in the genome sample, which is suitable for various copy number variations, included but not limited to aneuploidy of chromosome, deletion of chromosome, and addition, micro-deletion and micro-repetition of chromosome fragments.

It should note that, it would be appreciated by those skilled in the art that, the above-described characteristics and advantages of the method of determining whether copy number variation presents in a genome sample is also suitable to the computer readable medium, which are omitted for convenience and brevity.

Reference will be made in detail to examples of the present disclosure. It would be appreciated by those skilled in the art that the following examples are explanatory, and cannot be construed to limit the scope of the present disclosure. If the specific technology or conditions are not specified in the examples, a step will be performed in accordance with the techniques or conditions described in the literature in the art (for example, referring to J. Sambrook, et al. (translated by Huang PT), Molecular Cloning: A Laboratory Manual, 3rd Ed., Science Press) or in accordance with the product instructions. If the manufacturers of reagents or instruments are not specified, the reagents or instruments may be commercially available, for example, from Illumina.

General Method

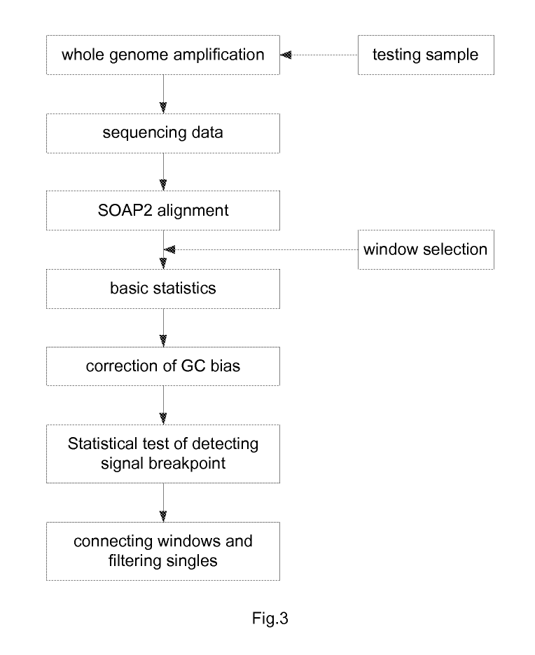

Referring to FIG. 3, the method of determining whether copy number variation presents in a genome sample used in examples comprises:

Firstly, a whole genome sample is subjected to amplification, and then the amplified whole genome is sequenced to obtain reads (sequencing data);

Secondly, the obtained reads are aligned to a standard human genome reference sequence in NCBI database by SOAP2, to obtain location information of the reads in the genome. To avoid interference to analysis of copy number variation by repeat sequence, reads which are uniquely aligned to the human genome reference sequence are only selected for subsequent analysis.

Thirdly, a site of which the number of reads falling in two sides respectively having a statistical significance is found, which comprises following steps:

a) calculating the relative number of reads of the testing sample (a plurality of samples may be analyzed at the same time):

a window having a length of w is selected in the human genome reference sequence (w may be any integer greater than 1, for example 10 K to 10 M bp, 50 K to 1 M bp is preferred, 100 K to 300 K bp is more preferred, such as 150 K bp), the number of reads falling into each window r_{i,j} is calculated in al obtained reads, in which subscript i represents No. of the windows, subscript j represents No. of the samples, GC content of each window GC_{i,j} is also calculated, then the relative number of reads is calculated by

$${R}_{i , j} = {log}_{2} ( \frac{{r}_{i , j}}{{\overline{r}}_{j}} ) ,$$

in which the average number of reads is

$${\overline{r}}_{j} = \frac{1}{n} {\sum }_{i = 1}^{n} {r}_{i , j} ,$$

b) data correlation and normalization

in a coordinate system taking GC content as X-coordinate and the relative number of reads R as Y-coordinate, GC is divided into regions having same size from small to large, a mean value Mₛ of R in every region is calculated, s is No. of GC region;

for every window of the sample, the corrected relative number of reads is calculated by \tilde{R}_{i,j}=R_{i,j}−Mₛ, GC content of window is in the s-th GC region;

for every window of the sample, the normalized relative number of reads Z_{i,j} is calculated by,

$${Z}_{i , j} = ( {R}_{i , j} - {\tilde{R}}_{i , j} - {mean}_{j} ) / {SD}_{j} , \\ in which$$

$${mean}_{j} = \frac{1}{n} {\sum }_{i = 1}^{n} ( {R}_{i , j} - {\tilde{R}}_{i , j} ) , \\ {SD}_{j} = \sqrt{\frac{1}{n - 1} {\sum }_{i = 1}^{n} {( {R}_{i , j} - {\tilde{R}}_{i , j} - {mean}_{j} )}^{2}} ,$$

c) determining and screening breakpoints

determining breakpoints: for each site in the reference genome sequence, n windows (for example 100 windows) are selected respectively from two sides of the site as two populations for statistical test, one p value corresponding to each site is obtained by calculating difference between two sides of the site, m sites (such as 3000 sites) having the minimum p value as breakpoint

screening breakpoints: all arranged breakpoints are recorded as B_{c}={b₁, b₂, . . . bₛ}, each breakpoint presents between two successive fragments, in which such two fragments are regions respective from a previous breakpoint to said breakpoint and from said breakpoint to the a next breakpoint, all Z_{i,j} in such two fragments are subjected to statistical test (such as subjected to run test, which is a nonparametric test, evaluating significant difference between two populations using evenly distributed status of mixed elements with two population). The obtained p value (pₖ) is regarded as “bₖ is taken as significance of breakpoint”. A candidate breakpoint having the maximum p value pₖ is removed, which are repeated until all p value smaller than a final p value p_{final} of such chromosome;

obtaining the final p value: during detection, the above step of determining a plurality breakpoint is performed with a control sample as the testing sample, all arrange candidate breakpoints in whole genome are recorded as B_{c}={b₁, b₂, . . . bₛ}, each candidate breakpoint bₖ presents between two successive fragments, all Z_{i,j} in such two fragments are subjected to statistical test, the obtained p value (pₖ) is regarded as “bₖ is taken as significance of breakpoint”. A candidate breakpoint having the least significance p value pₖ is removed, which are repeated until the number of the candidate breakpoints is zero. A distribution diagram is plotted with the removed candidate breakpoint, a p value having a maximal changing trend is taken as the final p value (p_{final});

determining a detection window and verifying the detection window: after the screened breakpoints have been obtained, the detection window is determined. To further determining the detection window, a mean value of Z_{i,j} in such fragment is calculated, which is recorded as Z̅. If Z̅ exceeds a threshold, then copy number variation is determined presenting in such fragment, in which the threshold is determined as followings:

for each fragment after connecting windows, a mean value and a standard error of the normalization number of reads Z_{i,j} in such fragment of all control samples are calculated. As Z̅ in each fragment fits normal distribution, a range of threshold of such fragment when a cumulative probability is 0.05 is calculated according to the calculated mean value and standard error obtained in above steps, in which the range of threshold is used as the threshold filtering whether copy number variation presents in the fragment.

Example 1 Copy Number Variation Detection of Fetal Fragments with an Embryo Single Cell Sample, and Chromosome Aneuploid Detection with an Embryo Single Cell Sample

1. whole genome amplification: GenomePlex® Single Cell Whole Genome Amplification Kit from Sigma Aldrich Company was used in whole genome amplification with the two embryo single cell samples in the current example. The embryo single cell sample was trophoblast cell of the fifth day blastocysts, which was isolated from blastaea by a laser capture microdissection method. After the two embryo single cell samples were lysed, the whole genome amplification was performed in accordance with instructions for kit provided by manufacturer.

2. sequencing: in the current example, Hiseq2000 sequencing platform from Illumina Company was used in sequencing the amplified whole genome DNA from the two embryo single cell sample. According to instructions provided by Illumina Company, sequencing-library construction and sequencing on computer were performed, by which generated about 0.36 G data volume of each sample, distinguished by different index sequences. Using alignment software SOAP2, the reads obtained by sequencing were aligned to human genome reference sequencing in NCBI database, Build 36, to locate the obtained reads in the human genome reference sequence.

3. Data analysis

a) calculating the relative number of reads of a testing sample and a control sample (the control sample referred to a sample had normal karyotype)

The human genome reference sequence was divided into a plurality of windows having a length of 150K bp. The number of the reads obtained in step 2) falling in each window r_{i,j} was calculated, in which the subscript i represented No. of the plurality of windows, j represented No. of samples. GC content was also calculated for each window. The relative number of reads was calculated in accordance with the formula given in General Method.

b) data correction and normalization

in a coordinate system taking GC content as X-coordinate and the relative number of reads R as Y-coordinate, GC content was divided into a plurality of regions in a unit of 0.001, from small to large. A mean value Mₛ of R in every region was calculated, s was No. of GC region, which were shown in Table.1. The obtained reads were subjected to correction and normalization in accordance to the formula given in General Method.

TABLE 1
List of Mₛ in each GC content region during correction

| | |
|---|---|
| Sample S1 | Sample S2 |

| s | GC | Mₛ | GC | Mₛ |
|---|---|---|---|---|
| 1 | 0.255~0.256 | 2.45 | 0.255~0.256 | 2.74 |
| 2 | 0.314~0.315 | 0.04 | 0.336~0.337 | −0.26 |
| 3 | 0.317~0.318 | 0.22 | 0.337~0.338 | −0.21 |
| 4 | 0.319~0.32 | 0.01 | 0.338~0.339 | −0.18 |
| 5 | 0.32~0.321 | 0.19 | 0.339~0.34 | 0.16 |
| 6 | 0.321~0.322 | 0.13 | 0.34~0.341 | −0.73 |
| 7 | 0.322~0.323 | 0.11 | 0.341~0.342 | −0.3 |
| 8 | 0.323~0.324 | 0.12 | 0.342~0.343 | −0.28 |
| 9 | 0.324~0.325 | −0.08 | 0.343~0.344 | −0.36 |
| 10 | 0.325~0.326 | 0.02 | 0.344~0.345 | −0.31 |
| 11 | 0.326~0.327 | 0.39 | 0.345~0.346 | −0.19 |
| 12 | 0.327~0.328 | 0.15 | 0.346~0.347 | −0.18 |
| 13 | 0.328~0.329 | 0.11 | 0.347~0.348 | −0.25 |
| 14 | 0.329~0.33 | 0.22 | 0.348~0.349 | −0.33 |
| 15 | 0.33~0.331 | 0 | 0.349~0.35 | −0.28 |
| 16 | 0.331~0.332 | −0.04 | 0.35~0.351 | −0.33 |
| 17 | 0.332~0.333 | 0.12 | 0.351~0.352 | −0.14 |
| 18 | 0.333~0.334 | 0.12 | 0.352~0.353 | −0.24 |
| 19 | 0.334~0.335 | 0.06 | 0.353~0.354 | −0.23 |
| 20 | 0.335~0.336 | 0.14 | 0.354~0.355 | −0.15 |
| 21 | 0.336~0.337 | 0.1 | 0.355~0.356 | −0.21 |
| 22 | 0.337~0.338 | 0.08 | 0.356~0.357 | −0.19 |
| 23 | 0.338~0.339 | 0.08 | 0.357~0.358 | −0.18 |
| 24 | 0.339~0.34 | 0.1 | 0.358~0.359 | −0.14 |
| 25 | 0.34~0.341 | 0.15 | 0.359~0.36 | −0.09 |
| 26 | 0.341~0.342 | 0.12 | 0.36~0.361 | −0.15 |
| 27 | 0.342~0.343 | 0.11 | 0.361~0.362 | −0.13 |
| 28 | 0.343~0.344 | 0.06 | 0.362~0.363 | −0.13 |
| 29 | 0.344~0.345 | 0.17 | 0.363~0.364 | −0.09 |
| 30 | 0.345~0.346 | 0.09 | 0.364~0.365 | −0.13 |
| 31 | 0.346~0.347 | 0.14 | 0.365~0.366 | −0.08 |
| 32 | 0.347~0.348 | 0.08 | 0.366~0.367 | −0.06 |
| 33 | 0.348~0.349 | 0.11 | 0.367~0.368 | −0.06 |
| 34 | 0.349~0.35 | 0.13 | 0.368~0.369 | −0.08 |
| 35 | 0.35~0.351 | 0.08 | 0.369~0.37 | −0.06 |
| 36 | 0.351~0.352 | 0.14 | 0.37~0.371 | −0.09 |
| 37 | 0.352~0.353 | 0.13 | 0.371~0.372 | −0.03 |
| 38 | 0.353~0.354 | 0.12 | 0.372~0.373 | −0.01 |
| 39 | 0.354~0.355 | 0.13 | 0.373~0.374 | −0.03 |
| 40 | 0.355~0.356 | 0.12 | 0.374~0.375 | −0.06 |
| 41 | 0.356~0.357 | 0.15 | 0.375~0.376 | −0.04 |
| 42 | 0.357~0.358 | 0.14 | 0.376~0.377 | −0.04 |
| 43 | 0.358~0.359 | 0.16 | 0.377~0.378 | −0.01 |
| 44 | 0.359~0.36 | 0.14 | 0.378~0.379 | −0.01 |
| 45 | 0.36~0.361 | 0.14 | 0.379~0.38 | 0 |
| 46 | 0.361~0.362 | 0.14 | 0.38~0.381 | −0.01 |
| 47 | 0.362~0.363 | 0.15 | 0.381~0.382 | 0.03 |
| 48 | 0.363~0.364 | 0.09 | 0.382~0.383 | 0 |
| 49 | 0.364~0.365 | 0.1 | 0.383~0.384 | 0.01 |
| 50 | 0.365~0.366 | 0.14 | 0.384~0.385 | 0 |
| 51 | 0.366~0.367 | 0.12 | 0.385~0.386 | 0.04 |
| 52 | 0.367~0.368 | 0.11 | 0.386~0.387 | 0.03 |
| 53 | 0.368~0.369 | 0.12 | 0.387~0.388 | 0.03 |
| 54 | 0.369~0.37 | 0.15 | 0.388~0.389 | 0.04 |
| 55 | 0.37~0.371 | 0.15 | 0.389~0.39 | 0.03 |
| 56 | 0.371~0.372 | 0.14 | 0.39~0.391 | 0.05 |
| 57 | 0.372~0.373 | 0.09 | 0.391~0.392 | 0.02 |
| 58 | 0.373~0.374 | 0.11 | 0.392~0.393 | 0.03 |
| 59 | 0.374~0.375 | 0.13 | 0.393~0.394 | 0.05 |
| 60 | 0.375~0.376 | 0.11 | 0.394~0.395 | 0.07 |
| 61 | 0.376~0.377 | 0.12 | 0.395~0.396 | 0.05 |
| 62 | 0.377~0.378 | 0.13 | 0.396~0.397 | 0.07 |
| 63 | 0.378~0.379 | 0.08 | 0.397~0.398 | 0.06 |
| 64 | 0.379~0.38 | 0.13 | 0.398~0.399 | 0.03 |
| 65 | 0.38~0.381 | 0.08 | 0.399~0.4 | 0.08 |
| 66 | 0.381~0.382 | 0.06 | 0.4~0.401 | 0.08 |
| 67 | 0.382~0.383 | 0.12 | 0.401~0.402 | 0.1 |
| 68 | 0.383~0.384 | 0.1 | 0.402~0.403 | 0.09 |
| 69 | 0.384~0.385 | 0.11 | 0.403~0.404 | 0.08 |
| 70 | 0.385~0.386 | 0.08 | 0.404~0.405 | 0.09 |
| 71 | 0.386~0.387 | 0.07 | 0.405~0.406 | 0.09 |
| 72 | 0.387~0.388 | 0.07 | 0.406~0.407 | 0.1 |
| 73 | 0.388~0.389 | 0.07 | 0.407~0.408 | 0.06 |
| 74 | 0.389~0.39 | 0.07 | 0.408~0.409 | 0.07 |
| 75 | 0.39~0.391 | 0.1 | 0.409~0.41 | 0.08 |
| 76 | 0.391~0.392 | 0.06 | 0.41~0.411 | 0.06 |
| 77 | 0.392~0.393 | 0.06 | 0.411~0.412 | 0.05 |
| 78 | 0.393~0.394 | 0.06 | 0.412~0.413 | 0.09 |
| 79 | 0.394~0.395 | 0.05 | 0.413~0.414 | 0.06 |
| 80 | 0.395~0.396 | 0.04 | 0.414~0.415 | 0.08 |
| 81 | 0.396~0.397 | 0.06 | 0.415~0.416 | 0.05 |
| 82 | 0.397~0.398 | 0.03 | 0.416~0.417 | 0.04 |
| 83 | 0.398~0.399 | 0.02 | 0.417~0.418 | 0.09 |
| 84 | 0.399~0.4 | 0.09 | 0.418~0.419 | 0.06 |
| 85 | 0.4~0.401 | 0.02 | 0.419~0.42 | −0.01 |
| 86 | 0.401~0.402 | 0.01 | 0.42~0.421 | 0.09 |
| 87 | 0.402~0.403 | 0.03 | 0.421~0.422 | 0.08 |
| 88 | 0.403~0.404 | 0 | 0.422~0.423 | 0.06 |
| 89 | 0.404~0.405 | 0.03 | 0.423~0.424 | 0.08 |
| 90 | 0.405~0.406 | 0.02 | 0.424~0.425 | 0.03 |
| 91 | 0.406~0.407 | 0.03 | 0.425~0.426 | 0.06 |
| 92 | 0.407~0.408 | 0.02 | 0.426~0.427 | 0.05 |
| 93 | 0.408~0.409 | −0.01 | 0.427~0.428 | 0.06 |
| 94 | 0.409~0.41 | −0.06 | 0.428~0.429 | 0.03 |
| 95 | 0.41~0.411 | −0.06 | 0.429~0.43 | 0.04 |
| 96 | 0.411~0.412 | −0.04 | 0.43~0.431 | 0.05 |
| 97 | 0.412~0.413 | −0.04 | 0.431~0.432 | 0.01 |
| 98 | 0.413~0.414 | −0.02 | 0.432~0.433 | 0.04 |
| 99 | 0.414~0.415 | −0.05 | 0.433~0.434 | 0 |
| 100 | 0.415~0.416 | −0.07 | 0.434~0.435 | −0.02 |
| 101 | 0.416~0.417 | −0.08 | 0.435~0.436 | 0.01 |
| 102 | 0.417~0.418 | −0.11 | 0.436~0.437 | 0.04 |
| 103 | 0.418~0.419 | −0.07 | 0.437~0.438 | 0.01 |
| 104 | 0.419~0.42 | −0.09 | 0.438~0.439 | −0.01 |
| 105 | 0.42~0.421 | −0.13 | 0.439~0.44 | −0.01 |
| 106 | 0.421~0.422 | −0.1 | 0.44~0.441 | −0.01 |
| 107 | 0.422~0.423 | −0.12 | 0.441~0.442 | −0.01 |
| 108 | 0.423~0.424 | −0.11 | 0.442~0.443 | −0.06 |
| 109 | 0.424~0.425 | −0.17 | 0.443~0.444 | −0.04 |
| 110 | 0.425~0.426 | −0.14 | 0.444~0.445 | −0.07 |
| 111 | 0.426~0.427 | −0.14 | 0.445~0.446 | −0.11 |
| 112 | 0.427~0.428 | −0.15 | 0.446~0.447 | −0.13 |
| 113 | 0.428~0.429 | −0.19 | 0.447~0.448 | −0.08 |
| 114 | 0.429~0.43 | −0.18 | 0.448~0.449 | −0.11 |
| 115 | 0.43~0.431 | −0.18 | 0.449~0.45 | −0.07 |
| 116 | 0.431~0.432 | −0.21 | 0.45~0.451 | −0.16 |
| 117 | 0.432~0.433 | −0.26 | 0.451~0.452 | −0.08 |
| 118 | 0.433~0.434 | −0.23 | 0.452~0.453 | −0.06 |
| 119 | 0.434~0.435 | −0.21 | 0.453~0.454 | −0.15 |
| 120 | 0.435~0.436 | −0.25 | 0.454~0.455 | −0.22 |
| 121 | 0.436~0.437 | −0.25 | 0.455~0.456 | −0.16 |
| 122 | 0.437~0.438 | −0.24 | 0.456~0.457 | −0.19 |
| 123 | 0.438~0.439 | −0.23 | 0.457~0.458 | −0.14 |
| 124 | 0.439~0.44 | −0.29 | 0.458~0.459 | −0.15 |
| 125 | 0.44~0.441 | −0.28 | 0.459~0.46 | −0.21 |
| 126 | 0.441~0.442 | −0.41 | 0.46~0.461 | −0.1 |
| 127 | 0.442~0.443 | −0.28 | 0.461~0.462 | −0.2 |
| 128 | 0.443~0.444 | −0.36 | 0.462~0.463 | −0.19 |
| 129 | 0.444~0.445 | −0.33 | 0.463~0.464 | −0.12 |
| 130 | 0.445~0.446 | −0.35 | 0.464~0.465 | −0.3 |
| 131 | 0.446~0.447 | −0.36 | 0.465~0.466 | −0.29 |
| 132 | 0.447~0.448 | −0.3 | 0.466~0.467 | −0.18 |
| 133 | 0.448~0.449 | −0.47 | 0.467~0.468 | −0.27 |
| 134 | 0.449~0.45 | −0.38 | 0.468~0.469 | −0.24 |
| 135 | 0.45~0.451 | −0.43 | 0.469~0.47 | −0.28 |
| 136 | 0.451~0.452 | −0.4 | 0.47~0.471 | −0.25 |
| 137 | 0.452~0.453 | −0.34 | 0.471~0.472 | −0.24 |
| 138 | 0.453~0.454 | −0.5 | 0.472~0.473 | −0.44 |
| 139 | 0.454~0.455 | −0.45 | 0.473~0.474 | −0.37 |
| 140 | 0.455~0.456 | −0.5 | 0.474~0.475 | −0.36 |
| 141 | 0.456~0.457 | −0.47 | 0.475~0.476 | −0.31 |
| 142 | 0.457~0.458 | −0.49 | 0.476~0.477 | −0.41 |
| 143 | 0.458~0.459 | −0.47 | 0.477~0.478 | −0.41 |
| 144 | 0.459~0.46 | −0.52 | 0.478~0.479 | −0.41 |
| 145 | 0.46~0.461 | −0.58 | 0.479~0.48 | −0.36 |
| 146 | 0.461~0.462 | −0.61 | 0.48~0.481 | −0.44 |
| 147 | 0.462~0.463 | −0.64 | 0.481~0.482 | −0.37 |
| 148 | 0.463~0.464 | −0.55 | 0.482~0.483 | −0.38 |
| 149 | 0.464~0.465 | −0.57 | 0.483~0.484 | −0.46 |
| 150 | 0.465~0.466 | −0.68 | 0.484~0.485 | −0.52 |
| 151 | 0.466~0.467 | −0.57 | 0.485~0.486 | −0.57 |
| 152 | 0.467~0.468 | −0.78 | 0.486~0.487 | −0.47 |
| 153 | 0.468~0.469 | −0.75 | 0.487~0.488 | −0.55 |
| 154 | 0.469~0.47 | −0.64 | 0.488~0.489 | −0.45 |
| 155 | 0.47~0.471 | −0.74 | 0.489~0.49 | −0.74 |
| 156 | 0.471~0.472 | −0.57 | 0.49~0.491 | −0.52 |
| 157 | 0.472~0.473 | −0.69 | 0.491~0.492 | −0.59 |
| 158 | 0.473~0.474 | −0.73 | 0.492~0.493 | −0.57 |
| 159 | 0.474~0.475 | −0.74 | 0.493~0.494 | −0.59 |
| 160 | 0.475~0.476 | −0.84 | 0.494~0.495 | −0.54 |
| 161 | 0.476~0.477 | −0.79 | 0.495~0.496 | −0.63 |
| 162 | 0.477~0.478 | −0.81 | 0.496~0.497 | −0.69 |
| 163 | 0.478~0.479 | −0.78 | 0.497~0.498 | −0.63 |
| 164 | 0.479~0.48 | −0.71 | 0.498~0.499 | −0.7 |
| 165 | 0.48~0.481 | −0.94 | 0.499~0.5 | −0.69 |
| 166 | 0.481~0.482 | −0.8 | 0.5~0.501 | −0.64 |
| 167 | 0.482~0.483 | −0.74 | 0.501~0.502 | −0.75 |
| 168 | 0.483~0.484 | −0.78 | 0.502~0.503 | −0.71 |
| 169 | 0.484~0.485 | −0.95 | 0.503~0.504 | −0.85 |
| 170 | 0.485~0.486 | −0.81 | 0.504~0.505 | −0.67 |
| 171 | 0.486~0.487 | −0.96 | 0.505~0.506 | −0.97 |
| 172 | 0.487~0.488 | −1 | 0.506~0.507 | −0.81 |
| 173 | 0.488~0.489 | −0.91 | 0.507~0.508 | −0.72 |
| 174 | 0.489~0.49 | −0.86 | 0.508~0.509 | −0.75 |
| 175 | 0.49~0.491 | −0.85 | 0.509~0.51 | −0.6 |
| 176 | 0.491~0.492 | −1.01 | 0.51~0.511 | −0.78 |
| 177 | 0.492~0.493 | −1.11 | 0.511~0.512 | −0.76 |
| 178 | 0.493~0.494 | −0.94 | 0.512~0.513 | −0.75 |
| 179 | 0.494~0.495 | −1.01 | 0.513~0.514 | −0.82 |
| 180 | 0.495~0.496 | −0.95 | 0.514~0.515 | −0.75 |
| 181 | 0.496~0.497 | −0.99 | 0.515~0.516 | −1.15 |
| 182 | 0.497~0.498 | −1.09 | 0.516~0.517 | −0.68 |
| 183 | 0.498~0.499 | −1.17 | 0.517~0.518 | −0.73 |
| 184 | 0.499~0.5 | −0.96 | 0.518~0.519 | −1.07 |
| 185 | 0.5~0.501 | −1.02 | 0.519~0.52 | −1 |
| 186 | 0.501~0.502 | −1.06 | 0.52~0.521 | −0.93 |
| 187 | 0.502~0.503 | −1.13 | 0.521~0.522 | −0.99 |
| 188 | 0.503~0.504 | −1.48 | 0.522~0.523 | −1 |
| 189 | 0.504~0.505 | −1.16 | 0.523~0.524 | −1.01 |
| 190 | 0.505~0.506 | −0.8 | 0.524~0.525 | −1.17 |
| 191 | 0.506~0.507 | −1.22 | 0.525~0.526 | −1.13 |
| 192 | 0.507~0.508 | −1.06 | 0.526~0.527 | −1.14 |
| 193 | 0.508~0.509 | −1.31 | 0.527~0.528 | −0.73 |
| 194 | 0.509~0.51 | −1.27 | 0.528~0.529 | −1.01 |
| 195 | 0.51~0.511 | −1.05 | 0.529~0.53 | −1.15 |
| 196 | 0.511~0.512 | −1.37 | 0.53~0.531 | −1.03 |
| 197 | 0.512~0.513 | −1.39 | 0.531~0.532 | −1.06 |
| 198 | 0.513~0.514 | −1.43 | 0.532~0.533 | −1.05 |
| 199 | 0.514~0.515 | −1.45 | 0.533~0.534 | −1.42 |
| 200 | 0.515~0.516 | −1.3 | 0.534~0.535 | −0.89 |
| 201 | 0.516~0.517 | −1.38 | 0.535~0.536 | −1.8 |
| 202 | 0.517~0.518 | −0.94 | 0.536~0.537 | −0.81 |
| 203 | 0.518~0.519 | −1.48 | 0.537~0.538 | −0.89 |
| 204 | 0.519~0.52 | −1.48 | 0.538~0.539 | −0.91 |
| 205 | 0.52~0.521 | −0.91 | 0.539~0.54 | −0.96 |
| 206 | 0.521~0.522 | −0.89 | 0.54~0.541 | −1.98 |
| 207 | 0.522~0.523 | −1.9 | 0.541~0.542 | −0.29 |
| 208 | 0.523~0.524 | −1.46 | 0.542~0.543 | −1.28 |
| 209 | 0.524~0.525 | −2.02 | 0.543~0.544 | −1.84 |
| 210 | 0.525~0.526 | −1.39 | 0.544~0.545 | −1.41 |
| 211 | 0.526~0.527 | −1.72 | 0.545~0.546 | −0.54 |
| 212 | 0.528~0.529 | −1.08 | 0.547~0.548 | −1.31 |
| 213 | 0.529~0.53 | −1.42 | 0.548~0.549 | −1.11 |
| 214 | 0.53~0.531 | −1.71 | 0.549~0.55 | −1.38 |
| 215 | 0.531~0.532 | −2.27 | 0.55~0.551 | −1.5 |
| 216 | 0.532~0.533 | −1.78 | 0.551~0.552 | −1.22 |
| 217 | 0.533~0.534 | −1.55 | 0.552~0.553 | −0.8 |
| 218 | 0.535~0.536 | −1.25 | 0.553~0.554 | −1.32 |
| 219 | 0.536~0.537 | −1.09 | 0.554~0.555 | −1.79 |
| 220 | 0.537~0.538 | −2.02 | 0.556~0.557 | −1.3 |
| 221 | 0.54~0.541 | −2.16 | 0.557~0.558 | −1.48 |
| 222 | 0.541~0.542 | −1.64 | 0.558~0.559 | −1.7 |
| 223 | 0.544~0.545 | −2.3 | 0.559~0.56 | −1.55 |
| 224 | 0.546~0.547 | −2.51 | 0.561~0.562 | −1.62 |
| 225 | 0.548~0.549 | −2.7 | 0.563~0.564 | −1.68 |
| 226 | 0.549~0.55 | −1.77 | 0.564~0.565 | −1.47 |
| 227 | 0.55~0.551 | −1.08 | 0.569~0.57 | −1.42 |
| 228 | 0.551~0.552 | −2.13 | 0.58~0.581 | −1.74 |
| 229 | 0.553~0.554 | −2.19 | 0.583~0.584 | −2.43 |
| 230 | 0.555~0.556 | −2.04 | 0.6~0.601 | −1.79 |
| 231 | 0.556~0.557 | −1.93 | | |
| 232 | 0.562~0.563 | −2.51 | | |
| 233 | 0.572~0.573 | −1.85 | | |
| 234 | 0.574~0.575 | −2.74 | | |

c) Connecting windows

determining breakpoint, for each site in the reference genome sequence, 100 windows located at either side of the site were selected respectively from two sides of the site as two populations for run test, one p value corresponding to each site was obtained by calculating difference between two sides of the site, 3000 sites having the minimum p value as breakpoint.

screening breakpoint: all arranged breakpoints were recorded as B_{c}={b₁, b₂, . . . , bₛ}, each breakpoint presented between two successive fragments, in which such two fragments were regions respective from a previous breakpoint to said breakpoint and from said breakpoint to the a next breakpoint, all Z_{i,j} in such two fragments were subjected to run test. The obtained p value (pₖ) was regarded as “bₖ was taken as significance of breakpoint”. A candidate breakpoint having the maximum p value pₖ was removed, which were repeated until all p value smaller than the final p value p_{final} of such chromosome being as 1.1×10⁻⁵⁰.

d) after the breakpoints were screened out, a region between two successive breakpoints was determined as a detection window, so as to connect windows. To further filter fragments obtained by connecting windows, a mean value of Z_{i,j} in such fragment was calculated, which was recorded as Z̅. If Z̅ exceeded a threshold, then copy number variation was determined presenting in such fragment. −1.645 was used as the first threshold, and 1.645 was used as the second threshold.

4. Result

Table.2 showed a detection result list of copy number variation after whole genome amplifying the embryo single cell sample in current example.

TABLE 2
Detection result list of copy number variation after whole genome
amplifying the embryo single cell sample in current example

| | chro- | starting | terminating | | | |
|---|---|---|---|---|---|---|
| | mo- | point | point | size of | type of | |
| No. | some | of CNV | of CNV | CNV | CNV | Involved region |
| S1 | 5 | 63,429 | 23,496,649 | 23.4M | deletion | 4q34.3→q35.2 |
| | 12 | 16,037 | 18,926,068 | 18.9M | repeat | 7p21.1→p22.3 |
| S2 | 21 | 1 | 46,944,323 | 46.9M | repeat | 21p13→q22.3 |

It could be seen from Table.2 that using the method of determining whether copy number variation presents in a genome sample according to embodiments of the present disclosure, various types of copy number variation could be effectively determined.

### Example 2

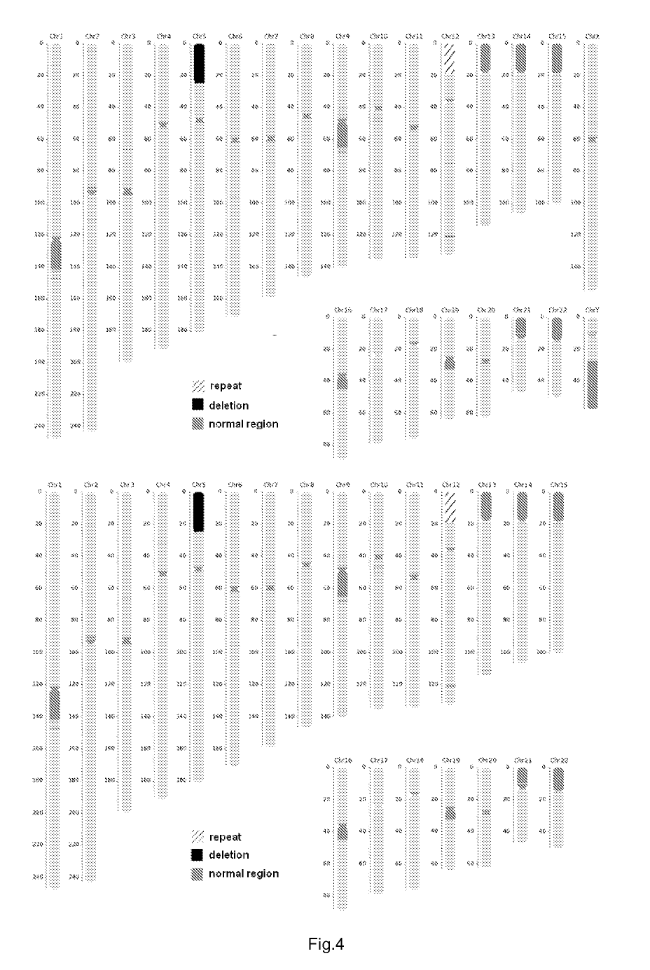

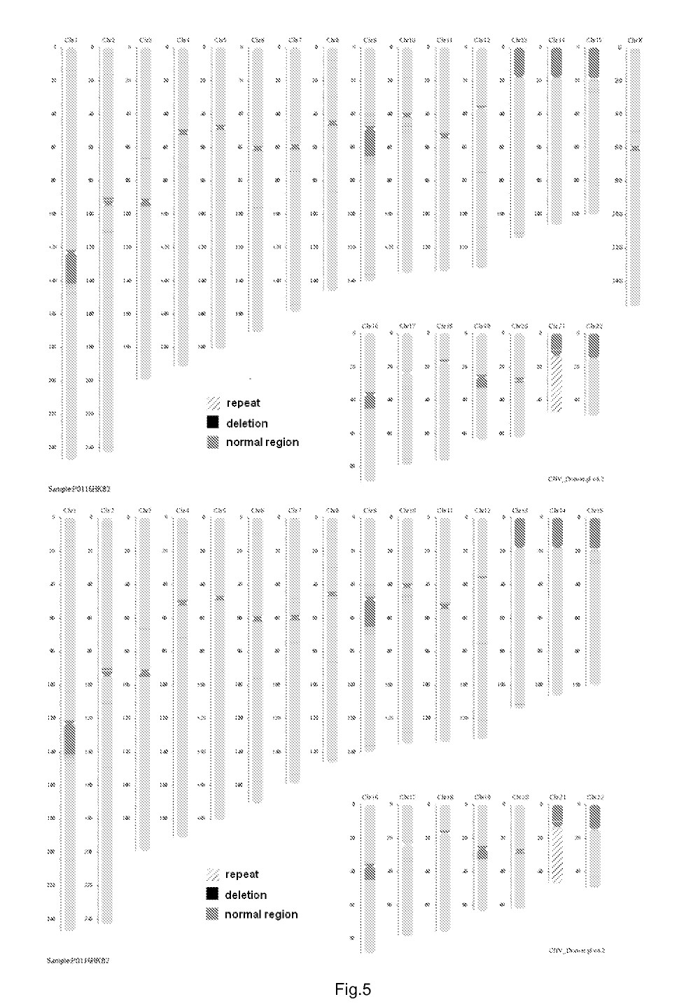

Using the embryo single cell sample same as that in Example 1, all steps were rereated as Example 1 except the genome DNA was directly subjected to sequencing (without firstly subjected to whole genome amplification). Comparison result between Example 1 and Example 2 was shown in Table 3, FIG. 4 and FIG. 5.

TABLE 3
Comparision result of detecting copy number variation of
reads obtained by subjected each genome sample to whole genome
amplification and not to whole genome amplification

| | | | sequencing result | |
|---|---|---|---|---|
| | | sequencing result | of embryo single | |
| | | of embryo single | cell genome DNA | |
| | | cell genome DNA | by the method of | |
| | chromo- | (without sub- | the present dis- | determining |
| No. | some | jected to WGA) | closure | result |
| S1 | 5 | deletion: | Deletion: | consistent |
| | | 10,002- | 63,429- | |
| | | 23,312,155 | 23,496,649 | |
| | 12 | repeat: | repeat: | consistent |
| | | 145,741- | 16,037- | |
| | | 14,780,155 | 18,926,068 | |
| S2 | 21 | 21 trisomy | 21 trisomy | consistent |

It could be seen from data in Table.3 and images of chromosome karyotype in FIG. 4 and FIG. 5 that the detection results of reads copy number variation between the genome DNA sample which was subjected to whole genome amplification and the genome DNA sample which was not subjected to whole genome amplification were consistent. For difference of staring and terminating points of “deletion” or “repeat” in Table.3, as the boundary of copy number variation was hard to be accurately determined, in general for the primary window having a length of about 150K, two boundaries having difference within a range of 100 to 300 Kb could be determined as being fully consistent, two boundaries having difference within a range of 300 Kb to 1 Mb could be determined as being quite consistent. Since the difference between boundaries of copy number variation determined by the two methods in Table 3. was within the range of 100 to 300 Kb or within the range of 300 Kb to 1 Mb, it could determine that the boundaries of copy number variation determined by the two methods were consistent.

### INDUSTRIAL APPLICABILITY

The method, system and computer readable medium of determining whether copy number variation presents in a genome sample of the present disclosure may be effectively used to determine whether copy number variation presents in a genome sample.

Reference throughout this specification to “an embodiment,” “some embodiments,” “one embodiment”, “another example,” “an example,” “a specific examples,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example, “in an example,” “in a specific examples,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A method of determining whether copy number variation exists in a genome sample, comprising:
sequencing the genome sample, to obtain a sequencing result consisting of a plurality of reads;
aligning the sequencing result to a reference genome sequence to determine a distribution of the reads in the reference genome sequence;
determining a plurality of breakpoints in the reference genome sequence based on the distribution of the reads in the reference genome sequence, wherein the number of reads has significance at both sides of the breakpoints;
determining a detection window in the reference genome based on the plurality of the breakpoints;
determining a first parameter based on reads falling in the detection window; and
determining whether the copy number variation exists in the genome sample against the detection window based on a difference between the first parameter and a preset threshold.

2-5. (canceled)

6. The method of claim 1, wherein the genome sample is obtained from a single cell, and the method further comprises:
lysing the single cell, to release whole genome of the single cell; and
amplifying the whole genome to obtain the genome sample.

7-10. (canceled)

11. The method of claim 1, wherein the copy number variation is at least one selected from the group consisting of aneuploidy of chromosome, deletion of chromosome, addition of a chromosome fragment, micro-deletion of a chromosome fragment, and micro-repetition of chromosome fragments.

12. The method of claim 1, wherein the step of determining a plurality of breakpoints in the reference genome sequence further comprises:
dividing the reference genome sequence into a plurality of primary windows having a predetermined length, and determining reads falling into the primary windows;
for at least one site in the reference genome sequence, determining the number of reads falling in the primary windows having the same number at both sides of the site;
determining a p value of the site, wherein the p value represents that the number of reads falling in either side of the site has significance,
wherein the site is the breakpoint if the p value of the site is smaller than a final p value.

13. The method of claim 12, wherein the reads falling into each of the primary windows are uniquely-aligned reads.

14. The method of claim 12, wherein 100 of the primary windows are selected from either side of the site.

15. The method of claim 12, wherein the primary windows have a length of 100 Kbp to 200 Kbp.

16. The method of claim 12, wherein the final p value is 1.1×10⁻⁵⁰ or less.

17. The method of claim 12, wherein the step of determining the p value of the site further comprises:
for the site, selecting primary windows having the same number at either side of the site respectively, and calculating the relative number of reads falling in each primary window Rᵢ, wherein i represents the number of the primary windows, and
subjecting the relative number of reads falling in all primary windows Rᵢ to a run test, to thereby determine the p value of the site,
wherein the relative number of reads is determined by following formula:
$${R}_{i} = {log}_{2} ( \frac{{r}_{i}}{\overline{r}} ) ,$$
wherein rᵢ represents the number of reads falling in the i-th primary window, and
$$\overline{r} = \frac{1}{n} {\sum }_{i = 1}^{n} {r}_{i} ,$$
wherein
n represents the total number of the primary windows.

18. The method of claim 17, wherein subjecting the relative number of the reads falling in all primary windows to a run test further comprises:
subjecting the relative number of reads falling in each of the primary windows Rᵢ to a correction of GC content, to obtain a corrected relative number of reads \tilde{R}ᵢ;
determining a normalized number of reads falling in each of the primary windows Zᵢ based on the corrected relative number of reads; and
subjecting all of the normalized number of reads falling in each of the primary windows Zᵢ to a run test.

19. The method of claim 18, wherein the corrected relative number of reads \tilde{R}ᵢ is obtained by the following steps:
calculating a GC content of each primary window;
dividing the GC content into a plurality of regions in a unit of 0.001, and calculating a mean value Mₛ of the relative number of reads falling in each of the plurality of regions, wherein s represents the number of the plurality of regions;
determining the corrected relative number of reads \tilde{R}ᵢ based on the following formula:
\tilde{R}ᵢ=Rᵢ−Mₛ; and
determining the normalized number of reads Zᵢ based on the following formula:
$${Z}_{i} = ( {R}_{i} - {\tilde{R}}_{i} - mean ) / SD , wherein$$
$$mean = \frac{1}{n} {\sum }_{i = 1}^{n} ( {R}_{i} - {\tilde{R}}_{i} ) and , \\ SD = \sqrt{\frac{1}{n - 1} {\sum }_{i = 1}^{n} {( {R}_{i} - {\tilde{R}}_{i} - mean )}^{2}} .$$

20. The method of claim 19, wherein the step of determining a detection window in the reference genome based on the plurality of the breakpoints further comprises:
1) determining a plurality of candidate breakpoints, wherein other breakpoints exist both before and after the candidate breakpoints;
2) determining a p value of each candidate breakpoint, and removing a candidate breakpoint having the final p value;
3) performing the step 2) with the rest of the candidate breakpoints until p values of the rest of the candidate breakpoints are all smaller than the final p value, wherein the rest of the candidate breakpoints are taken as screened candidate breakpoints; and
4) determining a region between two successive screened candidate breakpoints as the detection window,
wherein the p value of the candidate breakpoint is obtained by the following steps:
selecting a region between the candidate breakpoint and a previous candidate breakpoint as a first candidate region, and selecting a region between the candidate breakpoint and a next candidate breakpoint as a second candidate region;
subjecting the normalized number of reads falling in the primary windows Zi, which are included both in the first candidate region and the second candidate region to a run test, to thereby determine the p value of the candidate breakpoints.

21. The method of claim 20, wherein the step of determining a first parameter based on the reads falling in the detection window further comprises
determining a mean value of the normalized number of reads Z̅ falling in all primary windows which are included in the detection windows, wherein the mean value of the normalized number of reads Z̅ is taken as the first parameter.

22. The method of claim 1, wherein the preset threshold comprises
a first threshold being −1.645 and a second threshold being 1.645.

23. The method of claim 1, wherein the reference genome sequence is at least one selected from the group consisting of the sequence of human chromosome 21, human chromosome 18, human chromosome 13, human chromosome X, and human chromosome Y.

24. A system for determining whether copy number variation exists in a genome sample, comprising:
a sequencing apparatus configured to sequence the genome sample for obtaining a sequencing result consisting of a plurality of reads;
an analysis apparatus connected to the sequencing apparatus, and configured to determine whether copy number variation exists in the genome sample based on the sequencing result, wherein the analysis apparatus further comprises:
an aligning unit configured to align the sequencing result to a reference genome sequence for determining a distribution of the reads in the reference genome sequence;
a breakpoint determining unit connected to the aligning unit, and configured to determine a plurality of breakpoints in the reference genome sequence based on the distribution of the reads in the reference genome sequence, wherein the number of reads has significance between two sides of the breakpoints;
a detection window determining unit connected to the breakpoint determining unit, and configured to determine a detection window in the reference genome based on the plurality of the breakpoints;
a parameter determining unit connected to the detection window determining unit, and configured to determine a first parameter based on reads falling in the detection window; and
a determining unit connected to the parameter determining unit, and configured to determine whether the copy number variation exists in the genome sample against the detection window based on a difference between the first parameter and a preset threshold.

25. The system of claim 24, further comprising a genome extracting apparatus configured to extract the genome sample from a biological sample.

26. The system of claim 24, wherein the sequencing apparatus further comprises:
a genome amplifying unit configured to amplify the genome sample;
a sequencing-library constructing unit connected to the genome amplifying unit, and configured to construct a sequencing-library with the amplified genome sample; and
a sequencing unit connected to the sequencing-library constructing unit, and configured to sequence the sequencing-library.

27. The system of claim 26, wherein the sequencing unit comprises at least one selected from the group consisting of Hiseq system, Miseq system, Genome Analyzer system, 454 FLX, SOLiD system, Ion Torrent system, and single molecule sequencing apparatus.

28-35. (canceled)

36. A computer readable medium, comprising an order configured to perform by a processor to determine whether copy number variation exists in a genome sample through the following steps:
aligning a sequencing result to a reference genome sequence to determine a distribution of reads in a reference genome sequence;
determining a plurality of breakpoints in the reference genome sequence based on the distribution of the reads in the reference genome sequence, wherein the number of reads has significance at both sides of the breakpoints;
determining a detection window in the reference genome based on the plurality of the breakpoints;
determining a first parameter based on reads falling in the detection window; and
determining whether the copy number variation exists in the genome sample against the detection window based on a difference between the first parameter and a preset threshold.

37. The computer readable medium of claim 36, wherein the step of determining a plurality of breakpoints in the reference genome sequence further comprises:
dividing the reference genome sequence into a plurality of primary windows having a predetermined length, and determining reads falling into the primary windows;
for at least one site in the reference genome sequence, determining the number of reads falling in the primary windows having the same number at both sides of the site; and
determining a p value of the site, wherein the p value represents that the number of reads falling in either side of the site has significance,
wherein if the p value of the site is smaller than a final p value, the site is the breakpoint.

38-48. (canceled)
